(19) United States
(12) Patent Application Publication
(10) Pub. No.: US 2013/0167618 A1
(43) Pub. Date: Jul. 4, 2013

(54) METHOD FOR TESTING LEAK TIGHTNESS

(71) Applicant: Werner Grosse Bley, Bonn (DE)

(72) Inventor: Werner Grosse Bley, Bonn (DE)

(73) Assignee: INFICON GMBH, Koln (DE)

(21) Appl. No.: 13/818,857

(22) PCT Filed: Aug. 22, 2011
(86) PCT No.: PCT/EP2011/064406

§ 371 Date: Mar. 20, 2013

(30) Foreign Application Priority Data
Aug. 26, 2010 (DE) 10 2010 035 432.5

(51) Int. Cl. G01M 3/04

(52) U.S. Cl. CPC G01M 3/04
USPC 73/40; 524/321

(57) ABSTRACT

In order to test water-bearing components for leak tightness, a coating (19) is provided, which comprises a mixture made of a water-soluble base substance and a generator substance. Upon contact with water, the coating (19) releases an indicator gas. The indicator gas is detected by a sensor (13).

The invention relates to a method for testing leak tightness of water-bearing components.

In quality testing of mass products, it is often required to perform a test for leak tightness. Thus, for instance, washing machines and dishwashers have to be tested in order to detect possible leaks in hose conduits and pipe conduits. In DE 10 2007 032 250 B3, there is described a device for detection of liquid leaks which comprises a large-surfaced, electrically non-conductive panel element with conductor traces arranged thereon. The conductor traces have a voltage applied to them. By measuring the electric resistance, the possible presence of a liquid drop on the panel element will be detected.

The older (not pre-published) patent application DE 10 2010 005 494.1 describes various methods for leak tightness testing, each of them performed by use of a generator substance which, when getting into contact with water, will release an indicator gas that can be detected by a leak detector. Said generator substance is accommodated in a vessel which will dissolve upon contact with water. To be counted among such vessels are also microcapsules. A danger exists that the generator substance might undergo a quick reaction caused by the influence of air humidity. In case that microcapsules are provided, these may happen to stick together upon contact with water or air humidity so that, due to the danger of blistering, the indicator gas (CO₂) will be released only to a limited extent.

It is an object of the invention to provide a method for leak tightness testing which can be easily performed and in which the generator substance can be easily adapted to different geometries.

The method of the invention is defined by claim 1.

According to the invention, leak tightness testing is performed by use of a coating comprising a mixture of a water-soluble base substance and a generator substance. Such a mixture can be applied very conveniently in the form of a liquid or a paste, whereupon it will harden and then tightly adhere to the supporting component until a contact with water will destroy the coating and release the indicator. It will then be possible to detect the indicator by use of a leak detection device.

Said coating can be applied by brush or spatula application and will then harden. It will conform to random geometries of the supporting structure. It can be applied onto potentially leaking water-bearing sites.

Thus, even without an enclosing casing, a leak from which a water drop escapes can be immediately detected and localized in a known manner by gas-based sniffing leak detection on the basis of the CO₂ development at the leak site.

According to a further variant, a bottom cover, provided with said coating, is arranged below the water-bearing components. Both variants also make it possible to visually detect the site of the leak because, at the site where a water drop impinges and respectively leaks out, the coating will become visibly dissolved.

The coating comprises a homogeneous mixture. Suited as a base substance is polyethylene glycol (PEG). PEG is a non-toxic polymer which is water-mixable and water-soluble in any ratio. Normally, PEG is indicated together with a numerical value representing the average relative molecular mass.

PEG having a molecular mass>400 has a liquid consistency, PEG 600 has a pasty consistency and PEGs<3000 are solid substances.

As a generator substance, a mixture of sodium hydrogen carbonate and citric acid or tartaric acid is suitable. These substances are organic or inorganic acids in solid (crystalline) form, so that they can be stirred into the water-free carrier substance PEG without reacting with the sodium hydrogen carbonate. The PEG will be heated (about 50°), thus rendering it possible to mix sodium hydrogen carbonate, acid and PEG without adding water so that no reaction will take place.

The invention further relates to a coating material for testing leak tightness of water-bearing components, said material comprising the features defined in claim 5.

Advantageous embodiments and modifications are indicated in the dependent claims.

Embodiments of the invention will be explained in greater detail hereunder with reference to the drawings.

In the drawings, the following is shown:

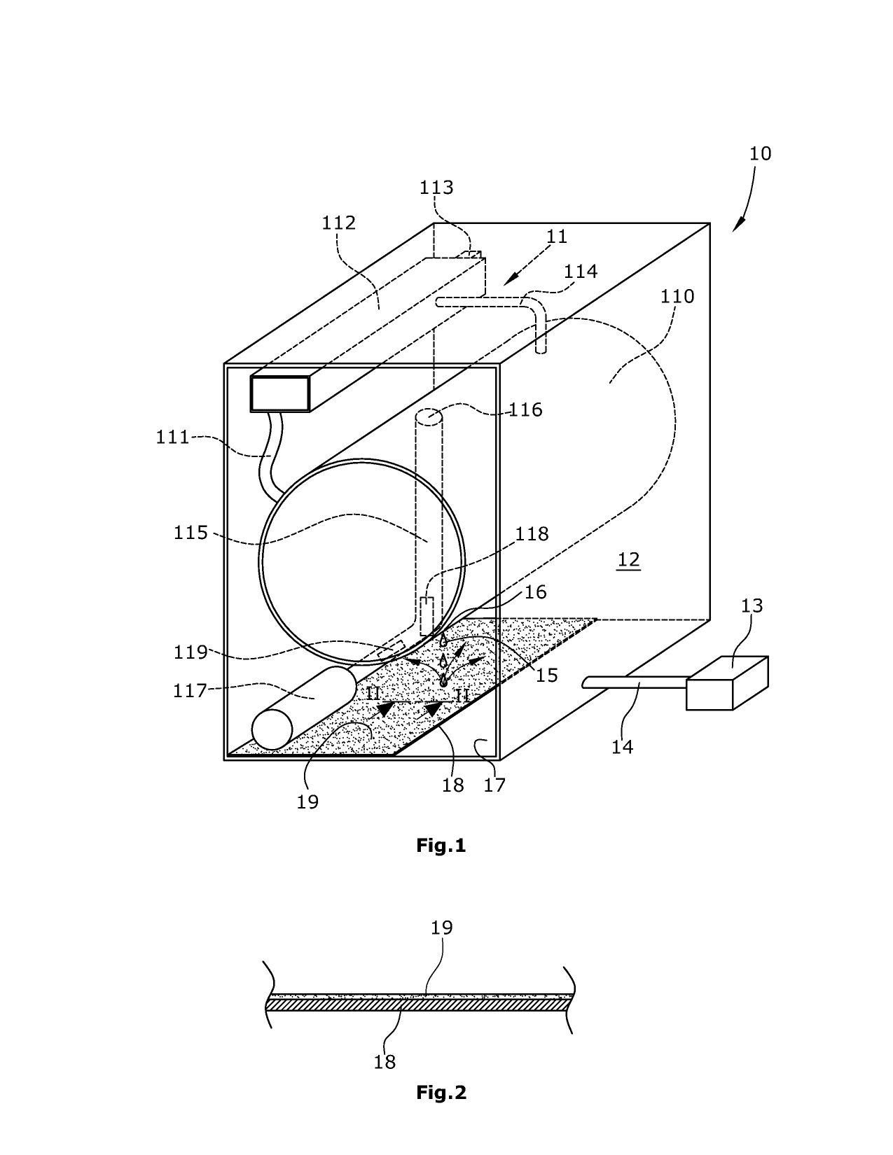

FIG. 1 is a view of the casing of a washing machine during leak tightness testing, wherein the washing machine is provided with a bottom cover, spread out in the interior of the casing, which carries the coating,

FIG. 2 is a cross-sectional view of said bottom cover, and

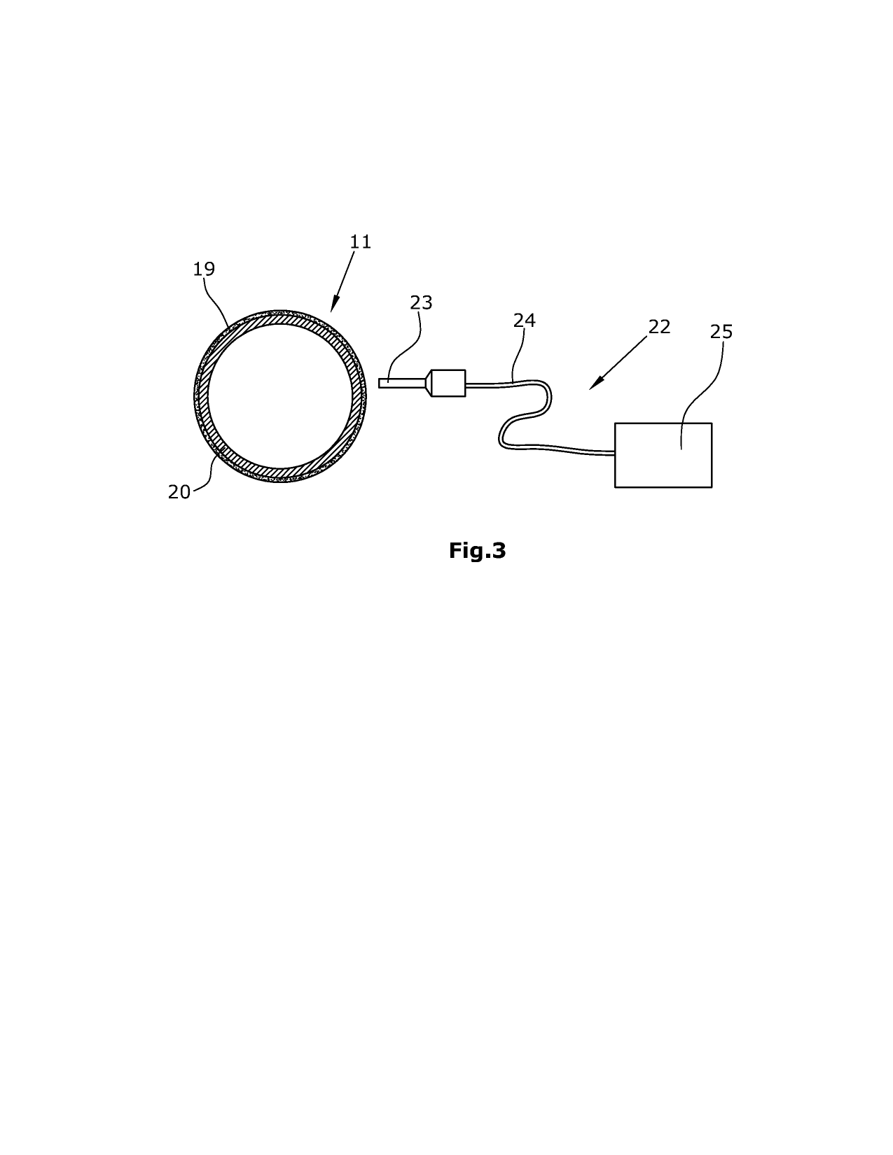

FIG. 3 is a view of a variant wherein a component with random design is provided with a coating.

FIG. 1 shows a casing 10 containing components 11 to be tested for leak tightness. Among such components, there are e.g. a suds container 110 which, via an injection tube 111, is connected to a dispenser box 112 which in turn is connected to a water supply duct 113. Further to be counted among such components are a suds-container venting tube 114 connecting the suds container 110 to the dispenser box 112, and a water drain tube 115 which at its upper end comprises a water drain outlet 116 and at its lower end is connected to a suds pump 117. Arranged on the suds container 110 are a pick-up element 118 for detection of the filling level, and a heater body sealing 119 which also is to be tested for leak tightness. All of said parts 110 to 119 are components in need of leak tightness testing. These components are situated in the interior 12 of casing 10 where an atmosphere prevails which is similar to the ambient air. The casing 10 encloses the interior 12 from all sides while, on the other hand, an absolute gas tightness of the interior will not be required. What is important is that the interior contains a gas volume which is delimited against the environment of casing 10, thus allowing for detection of the presence of an indicator substance in the interior 12.

For detecting the indicator, use is made of a sensor 13 connected via a line 14 to the interior 12. Sensor 13 includes a suction pump (not shown) operative to suction the gas from casing 10 and to discharge the gas into the ambient atmosphere. The sensor is e.g. of the type HLD5000 of the Inficon GmbH. This type of sensor is an infrared cuvette.

The leak tightness testing shall reveal whether small quantities of water in the form of drops are escaping from the components 11. Measurement of the air humidity in casing 10 would not be sufficiently sensitive or would take too much time. Drops 15 dripping down through a water leak 16 of component 11 will fall onto the bottom 17 and burst there. On bottom 17, a bottom cover 18 is spread out which can comprise a flexible film and which carries a coating 19 on its upper surface. The structure of said bottom cover 18 is shown in FIG. 2. Of advantage is a convection of the atmosphere in the interior 12 by means of a blower or by a drive of the drum (not shown) of the washing machine.

FIG. 1 shows one of the components 11 to be tested, which is a tube 20. Tube 20 is enclosed by a coating 19 containing the generator substance. Detection of the leak on the basis of CO₂ developing at the leak site will be performed by use of a sniffing leak detector 22 which is responsive to the indicator gas CO₂ and comprises a hand-held sniffing tip 23. The sniffing tip 23 is connected, via a capillary line 24, to a base device 25. The base device 25 includes a vacuum pump for suctioning gas into the sniffing tip 23, and a sensor which is selectively responsive to the indicator.

In both embodiments (FIGS. 2 and 3), the coating 19 comprises a mixture of a base substance, e.g. PEG 4000, and a generator substance. The generator substance comprises e.g. a stoichiometric mixture of sodium hydrogen carbonate and citric acid or tartaric acid, e.g. in a mixing ratio of 50/50%. The generator substance will be stirred into the base substance. The mixture can be applied onto any desired underlying surfaces by brush or spatula application and will then adhere thereon.

As an underlying surface, use can be made of a rigid bottom plate or also of a flexible film.

If said mixture is applied directly onto potentially leaking water-bearing sites, the development of the indicator (CO₂) will take place directly at the site of the leak. Thus, a leak can be detected and localized by a gas-operated sniffing leak detector, even if the component under testing is not contained in a casing.

1. A method for testing leak tightness of water-bearing components, wherein a coating comprising a mixture of a water-soluble base substance and a generator substance is applied onto the components under testing or onto a bottom surface arranged thereunder, said generator substance releasing a gaseous or vaporous indicator upon contact with water, and that the releasing of said indicator is detected by a sensor responsive to the indicator.

2. The method according to claim 1, wherein said coating is applied by brush or spatula application and will then harden.

3. The method according to claim 1, wherein, as a base substance, use is made of polyethylene glycol (PEG).

4. The method according to claim 1, wherein, as a generator substance, use is made of a mixture of sodium hydrogen carbonate and citric acid or tartaric acid.

5. A coating material for testing leak tightness of water-bearing components, comprising a mixture of a water-soluble base substance and a generator substance, said generator substance releasing a gaseous or vaporous indicator upon contact with water.

6. The coating material according to claim 5, wherein said base substance comprises polyethylene glycol (PEG).

7. The coating material according to claim 5, wherein said generator substance comprises a mixture of sodium hydrogen carbonate and citric acid or tartaric acid.
